(19) United States
(12) Patent Application Publication
(10) Pub. No.: US 2016/0180185 A1
(43) Pub. Date: Jun. 23, 2016

(54) ELECTRONIC DEVICE AND IMAGE RECOGNITION METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XUE-QIN ZHANG, Shenzhen (CN)

(21) Appl. No.: 14/935,622

(22) Filed: Nov. 9, 2015

(30) Foreign Application Priority Data
Dec. 17, 2014 (CN) 201410789969.1

(51) Int. Cl. G06K 9/32; G06K 9/34; G06K 9/00

(52) U.S. Cl. CPC G06K 9/3233; G06K 9/0055; G06K 9/344; G06K 2209/01

(57) ABSTRACT

An image recognition method includes obtaining an image using an electronic device. The image is processed using a predetermined image processing method. Once image features are identified from the image, a target image that matches the image is identified by searching a cloud storage device that is being connected to the electronic device, according to the image features.

### CROSS-REFERENCE TO RELATED APPLICATIONS

This application claims priority to Chinese Patent Application No. 201410789969.1 filed on Dec. 17, 2014, the contents of which are incorporated by reference herein.

### FIELD

The subject matter herein generally relates to image processing technology, and particularly to an electronic device and an image recognition method using the electronic device.

### BACKGROUND

An electronic device that includes a camera can be used to capture images for objects, such as plants, or animals. However, details of the object, for example, the name of the plant or animal may not be known.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including an image recognition system.

FIG. 2 illustrates a flowchart of one embodiment of a method of recognizing images using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

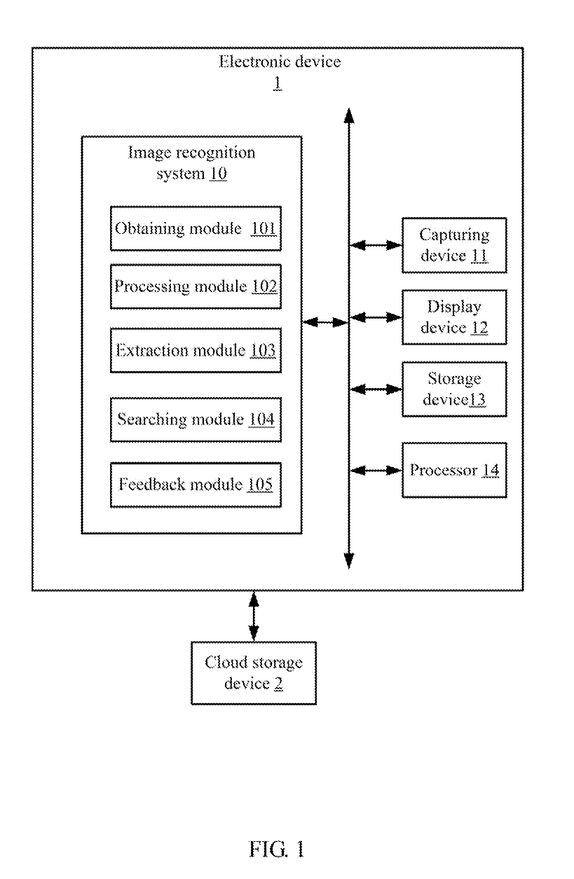

FIG. 1 is a block diagram of one embodiment of an electronic device. In at least one embodiment as shown in FIG. 1, an electronic device 1 includes an image recognition system 10, a capturing device 11, a display device 12, a storage device 13, and at least one processor 14. The electronic device 1 can be a smart phone, a personal digital assistant (PDA), a tablet computer, or any other suitable electronic device. FIG. 1 illustrates only one example of the electronic device 1 that can include more or fewer components than illustrated, or have a different configuration of the various components in other embodiments.

In one embodiment, the capturing device 11 can be a camera that can be used to capture images. The display device 12 can be a touch screen.

In one embodiment, the storage device 13 can be an internal storage device, such as a flash memory, a random access memory (RAM) for temporary storage of information, and/or a read-only memory (ROM) for permanent storage of information. The storage device 13 can also be an external storage device, such as an external hard disk, a storage card, or a data storage medium.

The at least one processor 14 can be a central processing unit (CPU), a microprocessor, or other data processor chip that performs functions of the electronic device 1.

In one embodiment, the electronic device 1 is wirelessly connected to a cloud storage device 2. The cloud storage device 2 prestores a plurality of images. Each of the plurality of images in the cloud storage device 2 corresponds to image features and image information that describes the images. In one embodiment, the plurality of images may include, but are not limited to, images of animals, plants, antiques, famous buildings, goods and chemical materials. The image features may include, but are not limited to, characteristics of geometry and color.

In one embodiment, the image recognition system 10 recognizes an image by searching the cloud storage device 2 for a target image that matches the image. In at least one embodiment, the image recognition system 10 can include an obtaining module 101, a processing module 102, an extraction module 103, a searching module 104, and a feedback module 105. The function modules 101-105 can include computerized codes in the form of one or more programs, which are stored in the storage device 13, and are executed by the at least one processor 14 of the electronic device 1. Details will be given in the following paragraphs.

The obtaining module 101 obtains one image. In one embodiment, the obtaining module 101 obtains the image by controlling the capturing device 11 to capture the image of an object. The object may be an animal, a plant, an antique, a famous building, or any other suitable object, such as a chemical material. In other embodiments, the obtaining module 101 may obtain the image via other methods such as downloading the image from the internet.

The image may include characters, such as numbers, Chinese characters, letters, words, symbols, for example. When the obtaining module 101 obtains an image of a painting with the capturing device 11, for example, the image includes characters such as a name of an author of the painting.

The processing module 102 processes the image using a predetermined image processing method. In one embodiment, the predetermined image processing method includes removing a background from the image and enhancing contrast of the image.

The processing module 102 determines whether the image includes characters using an optical character recognition (OCR) method.

When the image includes the characters, the processing module 102 extracts the characters from the image. In one embodiment, the processing module 102 further removes the characters from the image. For example, the processing module 102 can remove the characters from the image by covering the characters using a color that is the same as a background color of the characters.

The extraction module 103 identifies image features from the image. In one embodiment, the image features can be characteristics of geometry and color, and the extraction module 103 recognizes the image features using a preset algorithm such as a speeded-up robust features (surf) algorithm.

The searching module 104 identifies a target image that matches the image from the cloud storage device 2.

In one embodiment, the searching module 104 identifies the target image that matches the image, by searching the cloud storage device 2 according to the image features of the image. In one embodiment, the searching module 104 computes a similarity degree between each of the plurality of images stored in the cloud storage device 2 and the image, using the image features of each of the plurality of images and the image features of the image. When the similarity degree between a certain image of the plurality of images and the image is greater than a predetermined value, the searching module 104 determines the certain image to be the target image that matches the image. The searching module 104 further obtains the image information of the target image from the cloud storage device 2.

In other embodiments, when the image includes characters, and the characters are extracted from the image, the searching module 104 identifies the target image that matches the image, by searching the cloud storage device 2 for image information that includes the characters. For example, the searching module 104 first obtains image information that includes the characters from the cloud storage device 2, and then obtains the target image, which corresponds to the image information that includes the characters, from the cloud storage device 2.

The feedback module 105 displays the target image and the image information that corresponds to the target image on the display device 12.

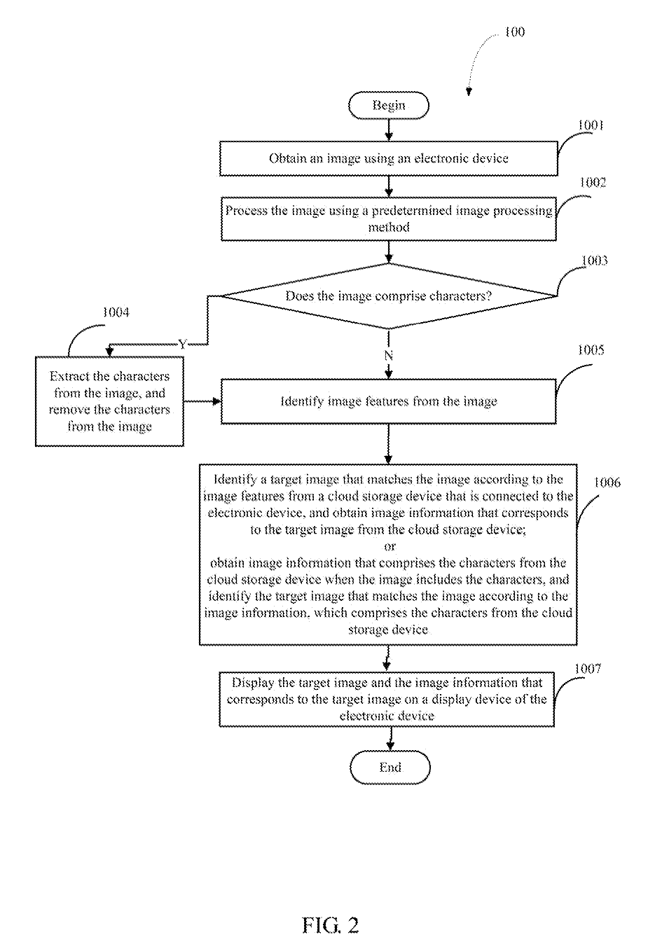

FIG. 2 illustrates a flowchart is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Additionally, the illustrated order of blocks is by example only and the order of the blocks can be changed according to the present disclosure. The exemplary method 100 can begin at block 1001. Depending on the embodiment, additional steps can be added, others removed, and the ordering of the steps can be changed.

At block 1001, an obtaining module obtains one image. In one embodiment, the obtaining module obtains the image by controlling a capturing device of an electronic device to capture the image of an object. The object may be an animal, a plant, an antique, a famous building, or any other object, such as a chemical material. In other embodiments, the obtaining module may obtain the image via other methods such as downloading the image from the internet.

It should be noted that the image may include characters, such as numbers, Chinese characters, letters, words, symbols, for example. When the obtaining module obtains an image of a painting for example, from the capturing device, the image includes characters such as a name of an author of the painting.

At block 1002, a processing module processes the image using a predetermined image processing method. In one embodiment, the predetermined image processing method includes removing a background from the image and enhancing contrast of the image.

At block 1003, the processing module determines whether the image includes characters using an optical character recognition (OCR) method. If the image includes the characters, the process goes to block 1004. If the image does not include the characters, the process goes to block 1005.

At block 1004, the processing module extracts the characters from the image. In one embodiment, the processing module further removes the characters from the image. For example, the processing module can remove the characters from the image by covering the characters using a color the same as a background color of the characters.

At block 1005, an extraction module identifies image features from the image. In one embodiment, the image features can be characteristics of geometry and color, and the extraction module recognizes the image features using a preset algorithm such as a speeded-up robust features (surf) algorithm.

At block 1006, a searching module identifies a target image that matches the image from a cloud storage device that is connected to the electronic device.

In one embodiment, the searching module identifies the target image that matches the image, by searching the cloud storage device according to the image features of the image. In one embodiment, the searching module computes a similarity degree between each of the plurality of images stored in the cloud storage device and the image, using the image features of each of the plurality of images and the image features of the image. When the similarity degree between a certain image of the plurality of images and the image is greater than a predetermined value, the searching module determines the certain image to be the target image that matches the image. The searching module further obtains the image information of the target image from the cloud storage device.

In other embodiments, when the image includes characters, and the characters are extracted from the image, the searching module identifies the target image that matches the image, by searching the cloud storage device for image information that includes the characters. For example, the searching module first obtains image information that includes the characters from the cloud storage device, and then obtains the target image, which corresponds to the image information that includes the characters, from the cloud storage device.

At block 1007, a feedback module displays the target image and the image information that corresponds to the target image on a display device of the electronic device.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented image recognition method using at least one processor of an electronic device, the method comprising:
obtaining an image using the electronic device;
processing the image using a predetermined image processing method;
identifying image features from the image;
searching a cloud storage device connected to the electronic device; and
identifying a target image that matches the image according to the image features.

2. The method according to claim 1, wherein the cloud storage device prestores a plurality of images, and each of the plurality of images corresponds to image information that describes the image.

3. The method according to claim 2, further comprising:
obtaining the image information of the target image from the cloud storage device; and
displaying the target image and image information of the target image on a display device of the electronic device.

4. The method according to claim 2, wherein after processing the image using the predetermined image processing method, the method further comprises:
determining whether the image comprises characters using optical character recognition (OCR) method;
extracting the characters from the image when the image comprises the characters; and
removing the characters from the image.

5. The method according to claim 4, further comprising:
obtaining image information that comprises the characters from the cloud storage device;
obtaining the target image, which corresponds to the image information that comprises the characters from the cloud storage device; and
displaying the target image and the image information that corresponds to the target image on a display device of the electronic device.

6. The method according to claim 1, wherein the predetermined image processing method comprises removing a background from the image and enhancing contrast of the image.

7. An electronic device comprising:
at least one processor;
a storage device being configured to store one or more programs that, when executed by the at least one processor, cause the at least one processor to:
obtain an image using the electronic device;
process the image using a predetermined image processing method;
identify image features from the image;
search a cloud storage device connected to the electronic device; and
identify a target image that matches the image according to the image features.

8. The electronic device according to claim 7, wherein the cloud storage device prestores a plurality of images, and each of the plurality of images corresponds to image information that describes the image.

9. The electronic device according to claim 8, wherein the at least one processor further:
obtaining the image information of the target image from the cloud storage device; and
displaying the target image and image information of the target image on a display device of the electronic device.

10. The electronic device according to claim 8, wherein after processing the image using the predetermined image processing method, the at least one processor further:
determining whether the image comprises characters using optical character recognition (OCR) method;
extracting the characters from the image when the image comprises the characters; and
removing the characters from the image.

11. The electronic device according to claim 10, wherein the at least one processor further:
obtaining image information that comprises the characters from the cloud storage device;
obtaining the target image, which corresponds to the image information that comprises the characters from the cloud storage device; and
displaying the target image and the image information that corresponds to the target image on a display device of the electronic device.

12. The electronic device according to claim 7, wherein the predetermined image processing method comprises removing a background from the image and enhancing contrast of the image.

13. A non-transitory storage medium having instructions stored thereon for recognizing images that, when executed by a processor of an electronic device, cause the electronic device to:
obtain an image using the electronic device;
process the image using a predetermined image processing method;
identify image features from the image;
search a cloud storage device connected to the electronic device; and identify a target image that matches the image according to the image features.

14. The non-transitory storage medium according to claim 13, wherein the cloud storage device prestores a plurality of images, and each of the plurality of images corresponds to image information that describes the image.

15. The non-transitory storage medium according to claim 14, wherein the instructions further cause the electronic device to recognize the images by:
obtaining the image information of the target image from the cloud storage device; and
displaying the target image and image information of the target image on a display device of the electronic device.

16. The non-transitory storage medium according to claim 14, wherein after processing the image using the predetermined image processing method, the instructions further cause the electronic device to recognize the images by:
determining whether the image comprises characters using optical character recognition (OCR) method;
extracting the characters from the image when the image comprises the characters; and
removing the characters from the image.

17. The non-transitory storage medium according to claim 16, wherein the instructions further cause the electronic device to recognize the images by:
obtaining image information that comprises the characters from the cloud storage device;
obtaining the target image, which corresponds to the image information that comprises the characters from the cloud storage device; and
displaying the target image and the image information that corresponds to the target image on a display device of the electronic device.

18. The non-transitory storage medium according to claim 13, wherein the predetermined image processing method comprises removing a background from the image and enhancing contrast of the image.
